(19) United States
(12) Patent Application Publication
(10) Pub. No.: US 2014/0027151 A1
(43) Pub. Date: Jan. 30, 2014

(54) SHIELDED CABLE

(71) Applicant: HITACHI CABLE, LTD., Tokyo (JP)

(72) Inventors: Detian HUANG, Hitachi (JP); Hiroshi KOMURO, Hitachi (JP); Takanobu WATANABE, Hitachi (JP); Norihiro NISHIURA, Hitachi (JP)

(73) Assignee: HITACHI CABLE, LTD., Tokyo (JP)

(21) Appl. No.: 13/763,912

(22) Filed: Feb. 11, 2013

(30) Foreign Application Priority Data
Jul. 25, 2012 (JP) 2012-164884

(51) Int. Cl. H01B 7/17

(52) U.S. Cl. CPC H01B 7/17
USPC 174/109

(57) ABSTRACT

A shielded cable includes an electric wire bundle configured such that a plurality of electric wires are bundled, a first band-shaped member configured to be spirally wound so as to cover the electric wire bundle, a second band-shaped member configured to be spirally wound on the outer periphery of the first band-shaped member, and a drain wire configured to be arranged between the first band-shaped member and the second band-shaped member. The first band-shaped member and the second band-shaped member include a metal layer including a conductive metal and a resin layer including an insulating resin, and are wound such that the metal layers thereof face each other across the drain wire. The first band-shaped member, the second band-shaped member and the drain wire are wound in the same direction to the electric wire bundle.

The present application is based on Japanese patent application No. 2012-164884 filed on Jul. 25, 2012, the entire contents of which are incorporated herein by reference.

### BACKGROUND OF THE INVENTION

1. Field of the Invention

This invention relates to a shielded cable configured such that a plurality of electric wires are covered with a conductive metal.

2. Description of the Related Art

Conventionally, for example, as a cable used for an application such as a connection of a computer or a television receiver and a peripheral device, a shielded cable configured such that a plurality of electric wires are shielded together is known (refer to JP-A-2006-164754 and JP-A-2011-222262).

The shielded cable described in JP-A-2006-164754 includes a shield layer formed to have a reticular structure by weaving a bundle of element wires on a periphery of a plurality of electric wires (conductive wires), the bundle of element wires being configured such that element wires comprised of copper or a copper alloy containing copper as a main component are bundled. In the shield layer, gaps that are not covered with the bundle of element wires are formed adjacent to areas in which two bundles of element wires intersecting with each other are overlapped. In the shielded cable described in JP-A-2006-164754, in order to ensure the bend lifetime, if the total area covered with the bundles of element wires in the shield layer is defined as a1 and the total area of the gaps is defined as a2, a braid density obtained by a calculation formula [{a1/(a1+a2)}×100] is configured to be 85 to 90%.

The shielded cable described in JP-A-2011-222262 is configured such that a metal foil resin tape (a tape configured such that a metal foil is formed on a surface of a resin tape) is spirally wound round a periphery of a plurality of electric wires (signal wires) in a lump. In addition, the shielded cable is configured such that one end in a width direction thereof is folded back and a lap winding is carried out such that the parts folded back are overlapped with each other, thereby metal foils in the parts folded back are electrically brought into contact with each other, so that a shield performance (an electromagnetic interference (EMI) characteristic) is enhanced. In addition, between the metal foil resin tape and an outer cover, a drain wire configured to be in contact with the metal foil of the metal foil resin tape is arranged longitudinally, so that facilitation of connection processing for electrically grounding the metal foil resin tape is enhanced.

### SUMMARY OF THE INVENTION

The shielded cable of JP-A-2006-164754 that includes the braided shield layer is desirably provided with a low braid density for securing the flexibility and bendability. However, since the lowering of the braid density may lead to the lowering of the shield performance, the problem arises that the compatibility between the flexibility and bendability and the shield performance is difficult.

The shielded cable of JP-A-2011-222262 may have a crack in the metal foil when the metal foil resin tape is folded back, thereby the shield performance may be lowered due to the continuity failure at a place where the crack has occurred. In addition, a difference in level may be formed by folding back the metal foil resin tape, whereby gaps are formed between the metal foil of the metal foil resin tape and the drain line by the difference in level. Also, there is a problem to be solved that the contact area between the metal foil and the drain line is lowered by the difference in level, thus the lowering of the contact area may become a factor for deterioration of the shield performance.

Accordingly, it is an object of the invention to provide a shielded cable that is capable of enhancing a shield performance.

(1) According to one embodiment of the invention, a shielded cable comprises:

an electric wire bundle configured such that a plurality of electric wires are bundled;

a first band-shaped member configured to be spirally wound so as to cover the electric wire bundle;

a second band-shaped member configured to be spirally wound on the outer periphery of the first band-shaped member; and

a drain wire configured to be arranged between the first band-shaped member and the second band-shaped member,

wherein the first band-shaped member and the second band-shaped member comprise a metal layer comprising a conductive metal and a resin layer comprising an insulating resin and are wound such that the metal layers thereof face each other across the drain wire, and

wherein the first band-shaped member, the second band-shaped member and the drain wire are wound in a same direction relative to the electric wire bundle.

In the above embodiment (1) of the invention, the following modifications and changes can be made.

(i) The first band-shaped member and the second band-shaped member have a same width, and

wherein the first band-shaped member, the second band-shaped member and the drain wire are wound at a same pitch.

(ii) The shielded cable comprises a tape member comprised of an insulating resin that is configured to be spirally wound between the electric wire bundle and the first band-shaped member in a same direction as that of the first band-shaped member.

(iii) The drain wire comprises an assembled twisted wire of copper or a copper alloy.

(iv) The drain wire has a cross-sectional area that is equal to that of a center conductor of at least any one of the plurality of the electric wires.

(v) The first band-shaped member and the second band-shaped member are configured such that the metal layer has a thickness of 7 to 9 μm and the resin layer has a thickness of 4 to 6 μm.

(vi) The first band-shaped member and the second band-shaped member are configured such that the metal layer comprises aluminum or an aluminum alloy.

(vii) The first band-shaped member and the second band-shaped member are configured such that the metal layer comprises copper or a copper alloy.

Points of the Invention

According to one embodiment of the invention, a shielded cable is constructed such that the surface of the metal layer of the first metal resin tape faces the surface of the metal layer of the second metal resin tape and the drain wire is arranged between the two metal layer surfaces. Thereby, even if the drain wire is displaced outward or inward in a radial direction with respect to the center axis C, e.g., due to flexure of the shielded cable, the drain wire can contact either of the two metal layer surfaces. Therefore, the shielded cable can have stable shield properties.

### BRIEF DESCRIPTION OF THE DRAWINGS

The preferred embodiments according to the invention will be explained below referring to the drawings, wherein:

FIG. 1 is a perspective view schematically showing a shielded cable according to an embodiment of the invention;

FIG. 2 is a transverse cross-sectional view schematically showing the shielded cable in a cross section perpendicular to a center axis of the shielded cable;

FIG. 3 is a longitudinal cross-sectional view schematically showing the shielded cable in a cross section along the center axis;

FIG. 4A is an enlarged cross-sectional view schematically showing a second metal resin tape;

FIG. 4B is an enlarged cross-sectional view schematically showing a first metal resin tape;

FIG. 5 is an explanatory view schematically showing one example of a connection configuration between a plurality of electric wires and a drain wire and a substrate in one end of the shielded cable; and

FIG. 6 is a graph showing a measurement result of shield effect in Example and Comparative Examples.

### DETAILED DESCRIPTION OF THE PREFERRED EMBODIMENTS

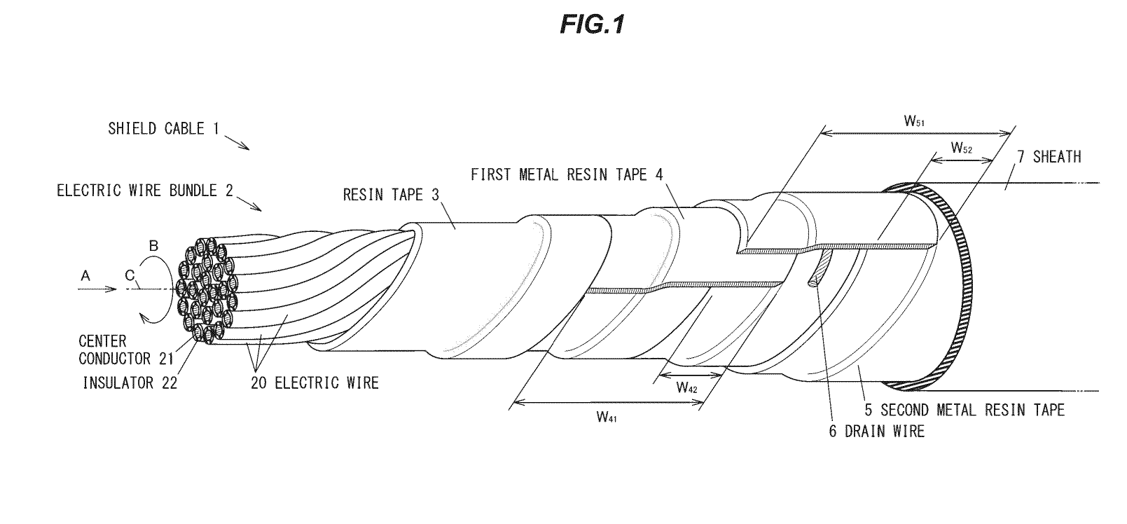

Hereinafter, a configuration of a shielded cable 1 according to the embodiment of the invention will be explained referring to FIGS. 1 to 4.

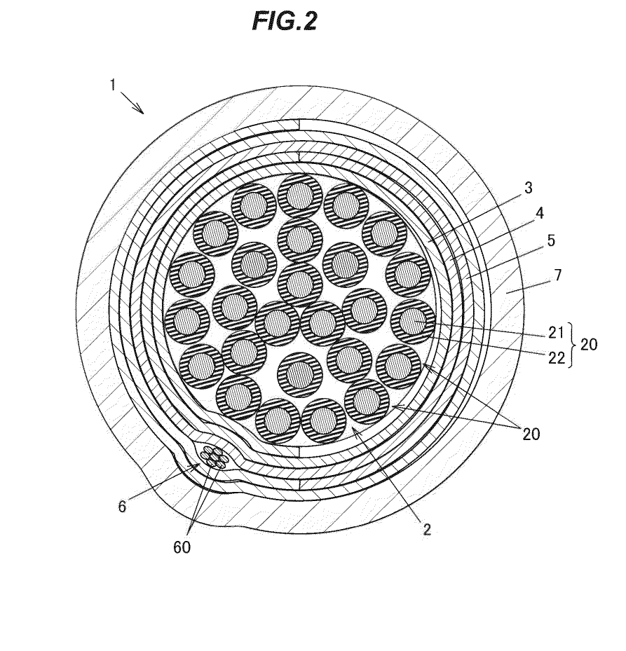

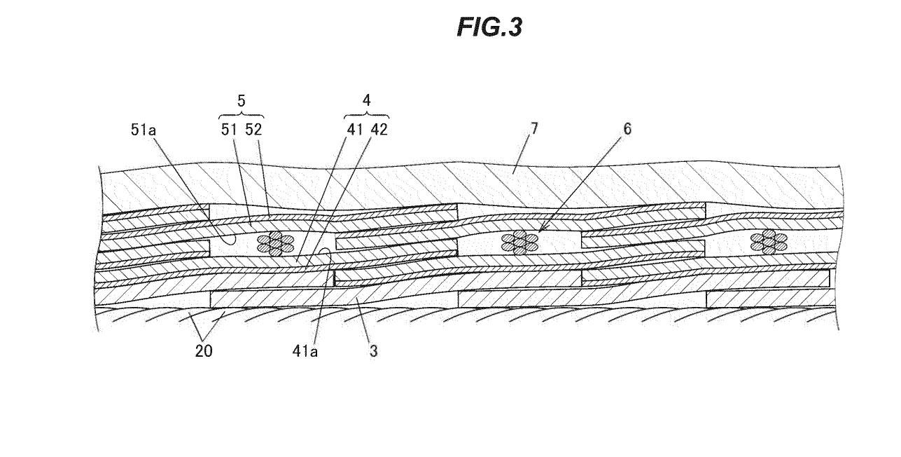

FIG. 1 is a perspective view schematically showing the shielded cable 1 according to an embodiment of the invention. FIG. 2 is a transverse cross-sectional view schematically showing the shielded cable 1 in a cross section perpendicular to a center axis C of the shielded cable 1. FIG. 3 is a longitudinal cross-sectional view schematically showing the shielded cable 1 in a cross section along the center axis C. Further, in FIG. 1, for convenience of explanation, a state that a part of constitutional elements of the shielded cable 1 is removed is shown.

The shielded cable 1 includes an electric wire bundle 2 configured such that a plurality (25 in the embodiment shown in FIG. 1) of electric wires 20 are bundled, a resin tape 3 as a tape member comprised of an insulating resin that is configured to collectively cover the plurality of the electric wires 20 of the electric wire bundle 2, a first metal resin tape 4 as a first band-shaped member configured to be spirally wound so as to cover the electric wire bundle 2 via the resin tape 3, a second metal resin tape 5 as a second band-shaped member configured to be spirally wound on the outer periphery of the first band-shaped member 4, and a drain wire 6 configured to be arranged between the first metal resin tape 4 and the second metal resin tape 5, and a sheath 7 comprised of a resin that is configured to house the above-mentioned constitutional elements.

The respective electric wires 20 includes a center conductor 21 comprised of a metal having good electrical conductivity such as copper and an insulator 22 comprised of a resin that is configured to cover the center conductor 21. The plurality of the electric wires 20 are collectively twisted in a direction of an arrow B (in a clockwise direction) in a view on an arrow A with a central focus in the center axis C of the shielded cable 1 so as to constitute the electric wire bundle 2. In the embodiment, the plurality of the electric wires 20 have the same diameter (cross-sectional area) with each other, but not limited to this, a part of the electric wires 20 can have a different diameter from those of the other electric wires 20. Namely, the diameters of the plurality of electric wires 20 can be inhomogeneous.

The resin tape 3 is a resin member having a band-shaped shape comprised of an insulating resin such as polyethylene terephthalate (PET), and is arranged between the electric wire bundle 2 and the first metal resin tape 4 in a state that the inner surface thereof is brought into contact with the electric wires 20 of the electric wire bundle 2. The resin tape 3 is spirally wound in a direction of the arrow B similarly to the electric wire bundle 2. The resin tape 3 is wound by a lap winding such that a part in the width direction (in a short side direction perpendicular to the longitudinal direction) is overlapped with each other.

As shown in FIG. 3, the first metal resin tape 4 includes a metal layer 41 comprised of a metal having electrical conductivity, and a resin layer 42 comprised of an insulating resin. The first metal resin tape 4 is wound in a side of the outer periphery of the resin tape 3 such that the metal layer 41 is arranged more exteriorly than the resin layer 42. The resin layer 42 is in contact with the resin tape 3, and a surface 41a of the metal layer 41 is in contact with the drain wire 6.

The second metal resin tape 5 includes a metal layer 51 comprised of a metal having electrical conductivity, and a resin layer 52 comprised of an insulating resin. The second metal resin tape 5 is wound in a side of the outer periphery of the first metal resin tape 4 such that the metal layer 51 is arranged more interiorly than the resin layer 52. A surface 51a of the metal layer 51 is in contact with the drain wire 6.

As shown in FIG. 2, the drain wire 6 is comprised of an assembled twisted wire obtained by twisting a plurality (7 in the embodiment) of element wires 60 comprised of copper or a copper alloy. The element wires 60 can be plated by tin or the like.

In addition, it is preferable that the drain wire 6 has a cross-sectional area (the total amount of cross-sectional areas of a plurality of electric wires 60 in a cross-section perpendicular to the center axis) that is equal to that of the center conductor 21 of the electric wire 20. In particular, if the cross-sectional area of the drain wire 6 is defined as s1 and the cross-sectional area of the center conductor 21 is defined as s2, it is preferable that s1 is 80 to 120% of s2, and it is more preferable that s1 is 90 to 110% of s2. Further, in case that the diameters of the plurality of the electric wires 20 are inhomogeneous, it is only necessary for a relationship between the cross-sectional area of the center conductor 21 of any one of the plurality of electric wires 20 and the cross-sectional area of the drain wire 6 to satisfy the above-mentioned condition.

The first metal resin tape 4 and the second metal resin tape 5 are wound such that the metal layer 41 of the first metal resin tape 4 and the metal layer 51 of the second metal resin tape 5 face each other across the drain wire 6. The first metal resin tape 4, the second metal resin tape 5 and the drain wire 6 are wound in the same direction with respect to the electric wire bundle 2 (in the direction of the arrow B shown in FIG. 1).

As shown in FIG. 1, the width dimension W₄₁ of the first metal resin tape 4 is equal to the width dimension W₅₁ of the second metal resin tape 5. The first metal resin tape 4 is spirally wound by a lap winding such that an end thereof in a width direction is overlapped, and the width dimension W₄₂ of the overlapped part is ¼ to ½ of the width dimension W₄₁. In the embodiment, the width dimension W₄₂ of the overlapped part is ⅓ of the width dimension W₄₁. Similarly, the second metal resin tape 5 is also spirally wound by a lap winding such that an end thereof in a width direction is overlapped, and the width dimension W₅₂ of the overlapped part is ¼ to ½ of the width dimension W₅₁. In the embodiment, the width dimension W₅₂ of the overlapped part is ⅓ of the width dimension W₅₁.

The first metal resin tape 4, the second metal resin tape 5 and the drain wire 6 are wound at the same pitch. Here, the pitch means a distance that the first metal resin tape 4, the second metal resin tape 5 and the drain wire 6 travel along the center axis C while they go round in a circumferential direction (in a direction of the arrow B) with a central focus in the center axis C of the shielded cable 1.

In the embodiment, as shown in FIGS. 1 to 3, the first metal resin tape 4 and the second metal resin tape 5 are arranged such that the second metal resin tape 5 is overlapped with the first metal resin tape 4, namely the positions in a direction of the center axis C of the ends in the width direction of the first metal resin tape 4 and the second metal resin tape 5 correspond substantially to each other. The drain wire 6 is in contact with the surface 41a of the metal layer 41 in the center part in the width direction of the first metal resin tape 4 and is in contact with the surface 51a of the metal layer 51 in the center part in the width direction of the second metal resin tape 5. Namely, the drain wire 6 can have line-contact with the metal layer 41 and the metal layer 51 throughout the whole length of a part sandwiched between the first metal resin tape 4 and the second metal resin tape 5.

In addition, the metal layer 41 of the first metal resin tape 4 and the metal layer 51 of the second metal resin tape 5 have directly contact with each other in each one end thereof in the width direction.

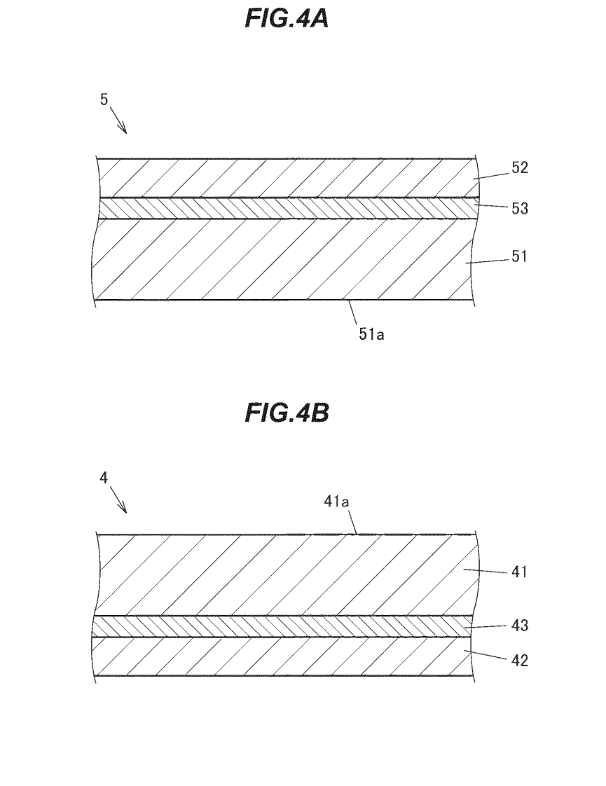

FIG. 4A is an enlarged cross-sectional view schematically showing the second metal resin tape 5, and FIG. 4B is an enlarged cross-sectional view schematically showing the first metal resin tape 4.

As shown in FIG. 4A, the second metal resin tape 5 includes an adhesive layer 53 between the metal layer 51 and the resin layer 52, and the metal layer 51 and the resin layer 52 are integrated by the adhesive layer 53. In addition, as shown in FIG. 4B, the first metal resin tape 4 includes an adhesive layer 43 between the metal layer 41 and the resin layer 42, and the metal layer 41 and the resin layer 42 are integrated by the adhesive layer 43.

The metal layer 41 and the metal layer 51 are comprised of aluminum or an, or copper or a copper alloy. Here, the aluminum alloy means an alloy that contains aluminum as a main component, and contains the other metals such as copper, zinc, iron, magnesium. In addition, the copper alloy means an alloy that contains copper as a main component, and contains the other metals such as chrome, zirconium, nickel, silicon, zinc, beryllium. The resin layer 42 and the resin layer 52 are comprised of, for example, PET.

The metal layer 41 and the metal layer 51 have a thickness of, for example, 7 to 10 μm. If the thickness is less than 7 μm, the metal layer 41 and the metal layer 51 are reduced in strength and the reduced in shield performance, thus it is not preferable. In addition, if the thickness is more than 10 μm, the shielded cable 1 is increased in weight, thus it is not preferable.

The resin layer 42 and the resin layer 52 have a thickness of, for example, 4 to 20 μm. If the thickness is less than 4 the resin layer 42 and the resin layer 52 are reduced in strength, thus it is not preferable. In addition, if the thickness is more than 20 μm, the shielded cable 1 is reduced in flexibility and bendability, thus it is not preferable.

In the embodiment, the metal layer 41 and the resin layer 42 in the first metal resin tape 4 has a thickness and a material in common with the metal layer 51 and the resin layer 52 in the second metal resin tape 5. Namely, the first metal resin tape 4 and the second metal resin tape 5 are configured to have common dimensions and components.

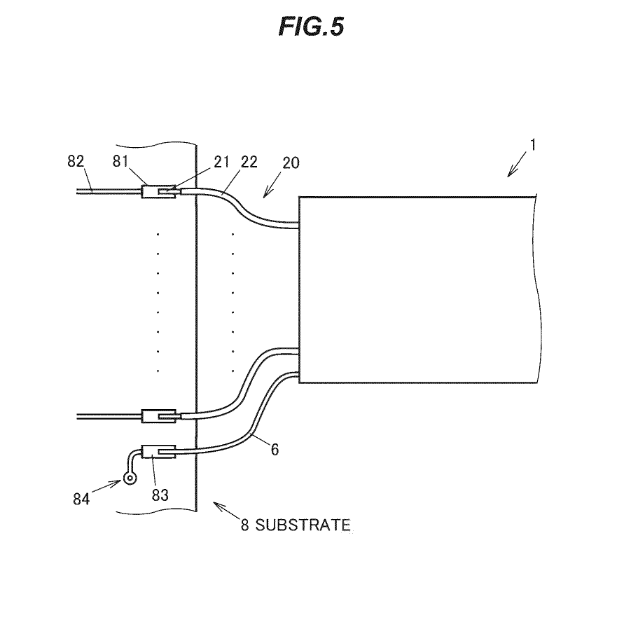

FIG. 5 is an explanatory view schematically showing one example of a connection configuration between the plurality of electric wires 20 and the drain wire 6 and a substrate 8 in one end of the shielded cable 1.

A plurality (25 in the embodiment) of pad electrodes 81 for signal line are disposed in the substrate 8, and a wire pattern 82 is connected to each of the pad electrodes 81. In addition, one pad electrode 83 for ground is disposed in the substrate 8, and the pad electrode 83 is electrically connected to a ground pattern (not shown) in the rear surface of the substrate 8 via through holes 84.

The plurality of the center conductors 21 of the electric wires 20 are connected and fixed to the pad electrodes 81, for example, by soldering respectively. The drain wire 6 is connected and fixed to the pad electrode 83, for example, by soldering. Further, the pad electrode 83 can be also disposed in the rear surface (a surface opposite to the surface in which the pad electrodes 81 is disposed) of the substrate 8.

Further, the shielded cable 1 can be manufactured by successively winding the resin tape 3, the first metal resin tape 4, the drain wire 6 and the second metal resin tape 5 in a side of the periphery of the plurality of electric wires 20 while twisting the electric wires 20. In this case, the pitch of the resin tape 3, the first metal resin tape 4, the drain wire 6 and the second metal resin tape 5 becomes identical to the pitch of the electric wire bundle 2.

Advantages of the Embodiment

According to the embodiment, the following advantages are obtained.

(1) The drain wire 6 is arranged between the metal layer 41 of the first metal resin tape 4 and the metal layer 51 of the second metal resin tape 5, and the first metal resin tape 4, the second metal resin tape 5 and the drain wire 6 are wound in the same direction, thus the drain wire 6 is prevented from intersecting the difference in level due to the overlapping of the first metal resin tape 4 or the second metal resin tape 5, so that the drain wire 6 can be in contact with the metal layer 41 and the metal layer 51 in a wide range. Due to this, the drain wire 6 is further improved in the contact with the metal layer 41 and the metal layer 51, so that the shielded cable 1 are further enhanced in the shield property.

(2) The surface 41a of the metal layer 41 of the first metal resin tape 4 faces the surface 51a of the metal layer 51 of the second metal resin tape 5 and the drain wire 6 is arranged between the surface 41a and the surface 51a, thus if the drain wire 6 is displaced outward in a radial direction with respect to the center axis C, for example, due to flexure of the shielded cable 1, the drain wire 6 comes into contact with the surface 51a of the metal layer 51, and if the drain wire 6 is displaced inward in a radial direction, the drain wire 6 comes into contact with the surface 41a of the metal layer 41. Namely, even if the drain wire 6 is displaced in a radial direction, the drain wire 6 can be brought into contact with at least any one of the metal layer 41 and the metal layer 51, thus stable shield properties can be obtained.

(3) The first metal resin tape 4 and the second metal resin tape 5 have the same width with each other, and the first metal resin tape 4, the second metal resin tape 5 and the drain wire 6 are wound at the same pitch, thus the drain wire 6 can be prevented from intersecting the difference in level due to the overlapping of the first metal resin tape 4 or the second metal resin tape 5. Due to this, the drain wire 6 can have line-contact with the metal layer 41 and the metal layer 51 throughout the whole length of a part sandwiched between the metal layer 41 and the metal layer 51, and the drain wire 6 is further improved in the contact with the metal layer 41 and the metal layer 51, so that the shielded cable 1 are further enhanced in the shield property.

(4) If the metal layer 41 of the first metal resin tape 4 and the metal layer 51 of the second metal resin tape 5 are comprised of aluminum or a an aluminum alloy, the shielded cable 1 can be reduced in weight and cost, for example, in comparison with a case that the metal layers 41, 51 are comprised of copper or a copper alloy.

(5) If the metal layer 41 of the first metal resin tape 4 and the metal layer 51 of the second metal resin tape 5 are comprised of copper or a copper alloy, electric resistance can be reduced, for example, in comparison with a case that the metal layers 41, 51 are comprised of aluminum or an aluminum alloy, thus the shielded cable 1 can be further enhanced in the shield property.

(6) The drain wire 6 has the same cross-sectional area as the center conductor 21 of the electric wire 20, thus the drain wire 6 can be connected in the same connection manner as that of the center conductor 21 in the end of the electric wire 20. Namely, this makes it possible to easily carry out terminal treatment in both ends of the shielded cable 1.

(7) The drain wire 6 is comprised of an assembled twisted wire of copper or a copper alloy, thus breaking of wire is prevented and simultaneously flexibility is enhanced, for example, in comparison with a case that it is comprised of a single wire conductor. Due to this, the drain wire 6 comes into contact with the metal layers 41, 51 more appropriately, thus even if the shielded cable 1 is bent, the shield property thereof can be prevented from being lowered.

### Example 1

Hereinafter, Example as a further particular embodiment of the invention including a comparison of a measurement result of shield effect with Comparative Examples will be explained. Further, in the Example, a particular example of the shielded cable 1 in the above-mentioned embodiment is cited, thus of course, the invention is not limited to this Example.

The shielded cable 1 according to the Example was configured such that the metal layers 41, 51 of the first and second metal resin tapes 4, 5 were comprised of aluminum, the resin layers 42, 52 were comprised of PET. The metal layers 41, 51 had a thickness of 9 μm and the resin layers 42, 52 had a thickness of 6 μm. The drain wire 6 was comprised of an assembled twisted wire configured such that 7 element wires 60 having a diameter of 0.127 mm were twisted together, and 25 center conductors 21 of the electric wire 20 were also respectively comprised of the assembled twisted wire configured such that 7 element wires having a diameter of 0.127 mm were twisted together.

### Comparative Example 1

The shielded cable 1A according to Comparative Example 1 was configured to use a braided shield of copper having a braid density of 65% instead of the second metal resin tape 5 and the drain wire 6 of the shielded cable 1 according to the above-mentioned Example. Namely, the shielded cable 1A has a double shield structure comprised of the first metal resin tape 4 and the braided shield of copper having a braid density of 65%.

### Comparative Example 2

The shielded cable 1B according to Comparative Example 2 was configured to use a braided shield of copper having a braid density of 85% instead of the first metal resin tape 4, the second metal resin tape 5 and the drain wire 6 of the shielded cable 1 according to the above-mentioned Example. Namely, the shielded cable 1B has a single shield structure comprised of the braided shield of copper having a braid density of 85%.

In addition, as to the thickness of the resin tape 3, a thickness of 0.5 mm was adopted in the shielded cable 1 according to the Example and the shielded cable 1B according to Comparative Example 2, and a thickness of 0.05 mm was adopted in the shielded cable 1A according to Comparative Example 1. The weight of the shielded cable 1 was 142 g/m, the weight of the shielded cable 1A was 163 g/m, and the weight of the shielded cable 1B was 172 g/m. The outer diameter of the sheath 7 was 12.7 mm in all the shielded cables 1, 1A, 1B.

By using the shielded cables 1, 1A, 1B, a measurement of shield effect was carried out by an absorption clamp method. In particular, the measurement of the shield effect was carried out such that the cable length was set to 10 m, one end thereof was terminated by a resistor of 50Ω, electromagnetic wave was applied thereto, and the shield effect was measured by using an absorption clamp manufactured by Kyoritsu Corporation and sold by the trade name of EMI clamp: model KT-10 and a network analyzer connected to the absorption clamp. The measurement frequency of 30 MHz to 1 GHz was used, and as the network analyzer, a network analyzer manufactured by Hewlett-Packard Company and sold by the trade name of Network Analyzer: model 8751A was used in the range of 30 MHz to 500 MHz, and a network analyzer manufactured by Agilent Technologies and sold by the trade name of Network Analyzer: model 8722ES was used in the range of 500 MHz to 1 GHz.

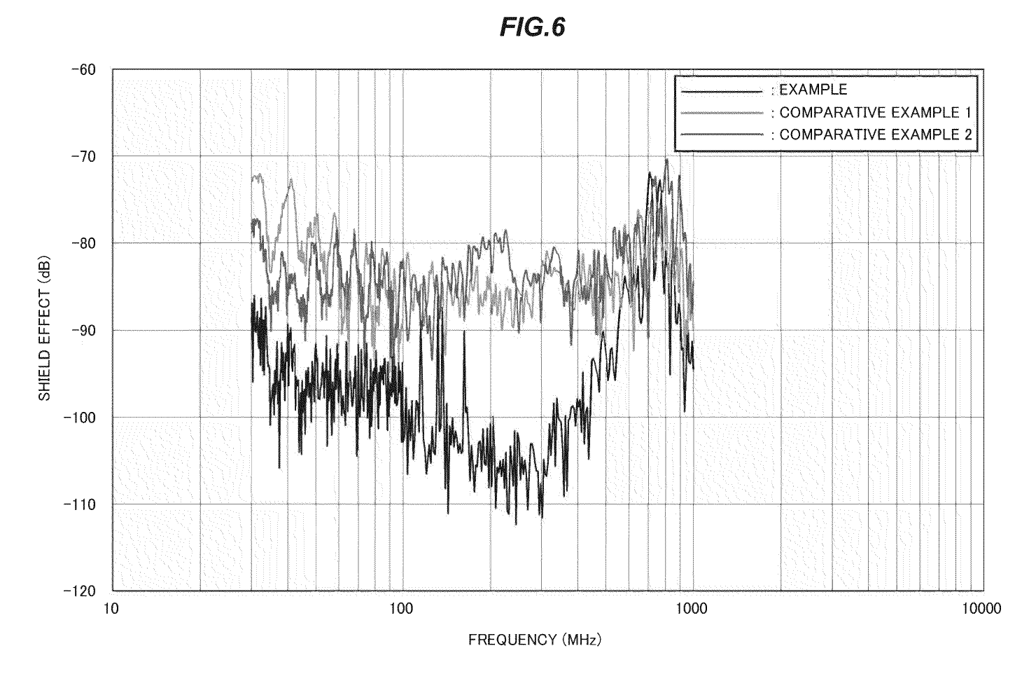

FIG. 6 shows a graph that shows the measurement result of the shield effect measured as mentioned above. In the graph, the measurement result of the shielded cable 1 according to the Example is shown by a solid line, that of the shielded cable 1A according to Comparative Example 1 is shown by a light gray solid line, and that of the shielded cable 1B according to the Comparative Example 2 is shown by a dark gray solid line. In addition, the graph shows that the higher shield effect is obtained in proportion as the line showing the measurement result is located lower.

As shown in FIG. 6, in the shielded cable 1 according to the Example, it is recognized that a remarkable effect is obtained particularly in the frequency band of not more than 500 MHz. Namely, the shielded cable 1 is more reduced in weight and cost than the shielded cables 1A, 1B that uses the braided shield, but it has higher shield performance. Further, an effect of the cost reduction is mainly due to the fact that the shield structure is formed without using copper.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, the number of the electric wire 20 only has to be not less than 2, and not particularly limited. Also, in addition to the first and second metal resin tapes 4, 5 and the drain wire 6, the other shield structures can be added. In addition, the twisting direction of the electric wire bundle 2, and the spirally winding direction of the first and second metal resin tapes 4, 5 and the drain wire 6 can be opposite to each other.

What is claimed is:

1. A shielded cable, comprising:
an electric wire bundle configured such that a plurality of electric wires are bundled;
a first band-shaped member configured to be spirally wound so as to cover the electric wire bundle;
a second band-shaped member configured to be spirally wound on the outer periphery of the first band-shaped member; and
a drain wire configured to be arranged between the first band-shaped member and the second band-shaped member,
wherein the first band-shaped member and the second band-shaped member comprise a metal layer comprising a conductive metal and a resin layer comprising an insulating resin and are wound such that the metal layers thereof face each other across the drain wire, and
wherein the first band-shaped member, the second band-shaped member and the drain wire are wound in a same direction relative to the electric wire bundle.

2. The shielded cable according to claim 1, wherein the first band-shaped member and the second band-shaped member have a same width, and
wherein the first band-shaped member, the second band-shaped member and the drain wire are wound at a same pitch.

3. The shielded cable according to claim 1, further comprising a tape member comprised of an insulating resin that is configured to be spirally wound between the electric wire bundle and the first band-shaped member in a same direction as that of the first band-shaped member.

4. The shielded cable according to claim 1, wherein the drain wire comprises an assembled twisted wire of copper or a copper alloy.

5. The shielded cable according to claim 1, wherein the drain wire has a cross-sectional area that is equal to that of a center conductor of at least any one of the plurality of the electric wires.

6. The shielded cable according to claim 1, wherein the first band-shaped member and the second band-shaped member are configured such that the metal layer has a thickness of 7 to 9 μm and the resin layer has a thickness of 4 to 6 μm.

7. The shielded cable according to claim 1, wherein the first band-shaped member and the second band-shaped member are configured such that the metal layer comprises aluminum or an aluminum alloy.

8. The shielded cable according to claim 1, wherein the first band-shaped member and the second band-shaped member are configured such that the metal layer comprises copper or a copper alloy.
